(19) United States
(12) Patent Application Publication
(10) Pub. No.: US 2014/0319361 A1
(43) Pub. Date: Oct. 30, 2014

(54) RADIATION IMAGING APPARATUS, METHOD OF MANUFACTURING THE SAME, AND RADIATION INSPECTION APPARATUS

(71) Applicant: CANON KABUSHIKI KAISHA, TOKYO (JP)

(72) Inventors: Takamasa Ishii, Honjo-shi (JP); Masato Inoue, Kumagaya-shi (JP); Shinichi Takeda, Honjo-shi (JP); Satoru Sawada, Fujioka-shi (JP); Taiki Takei, Yokohama-shi (JP); Kota Nishibe, Honjo-shi (JP)

(21) Appl. No.: 14/258,152

(22) Filed: Apr. 22, 2014

(30) Foreign Application Priority Data
Apr. 24, 2013 (JP) 2013-091787

(51) Int. Cl. G01T 1/20

(52) U.S. Cl. CPC G01T 1/20
USPC 250/363.01; 250/366; 29/592.1

(57) ABSTRACT

A radiation imaging apparatus, comprising a sensor array in which a plurality of sensors are arrayed, and scintillators arranged in a plurality of regions divided by members on the sensor array, wherein a relationship P2<P1 is satisfied, where P1 represents a pitch of the plurality of sensors in the sensor array and P2 represents a distance between centers of two adjacent ones of the members, which sandwich one of the plurality of regions therebetween.

### BACKGROUND OF THE INVENTION

1. Field of the Invention

The present invention relates to a radiation imaging apparatus, a method of manufacturing the same, and a radiation inspection apparatus.

2. Description of the Related Art

As a radiation imaging apparatus, an indirect conversion type radiation imaging apparatus including scintillators for converting radiation into light and sensors for detecting light from the scintillators can be used.

Japanese Patent Laid-Open No. 2002-202373 discloses a structure in which scintillators are divided by members so as to correspond to respective sensors. According to Japanese Patent Laid-Open No. 2002-202373, light generated by one of the scintillators divided by the members is reflected on the member toward a corresponding one of the sensors, and detected by the sensor, thereby improving the light sensitivity.

If an alignment shift occurs when forming members for dividing scintillators, each divided scintillator is formed across two adjacent sensors. This causes another sensor adjacent to a corresponding sensor to detect part of light generated by the divided scintillator, thereby degrading the sharpness of a radiation image. The radiation imaging apparatus is desirably provided to have a structure which is hardly influenced by an alignment shift.

### SUMMARY OF THE INVENTION

The present invention provides a radiation imaging apparatus having a large tolerance range of an alignment shift.

The first aspect of the present invention provides a radiation imaging apparatus, comprising a sensor array in which a plurality of sensors are arrayed, and scintillators arranged in a plurality of regions divided by members on the sensor array, wherein a relationship P2<P1 is satisfied, where P1 represents a pitch of the plurality of sensors in the sensor array and P2 represents a distance between centers of two adjacent ones of the members, which sandwich one of the plurality of regions therebetween.

The second aspect of the present invention provides a method of manufacturing a radiation imaging apparatus, comprising a first step of forming a sensor array in which a plurality of sensors are arrayed, and a second step of forming scintillators in a plurality of regions divided by members on the sensor array, wherein a relationship P2<P1 is satisfied where P1 represents a pitch of the plurality of sensors in the sensor array, and P2 represents a distance between centers of two adjacent ones of the members, which sandwich one of the plurality of regions therebetween.

Further features of the present invention will become apparent from the following description of exemplary embodiments with reference to the attached drawings.

### BRIEF DESCRIPTION OF THE DRAWINGS

FIG. 1 is a view for explaining an example of the overall arrangement of a radiation imaging apparatus;

FIG. 2 is a view for explaining an example of the sectional structure of a radiation imaging apparatus according to the first embodiment;

FIGS. 3A and 3B are plan views for explaining the radiation imaging apparatus according to the first embodiment;

FIG. 4 is a view for explaining an example of the sectional structure of a radiation imaging apparatus according to the second embodiment;

FIG. 5 is a view for explaining an example of the sectional structure of a radiation imaging apparatus according to the third embodiment;

FIGS. 6A and 6B are plan views for explaining the radiation imaging apparatus according to the third embodiment; and

FIG. 7 is a view for explaining an example of the arrangement of a radiation inspection apparatus.

### DESCRIPTION OF THE EMBODIMENTS

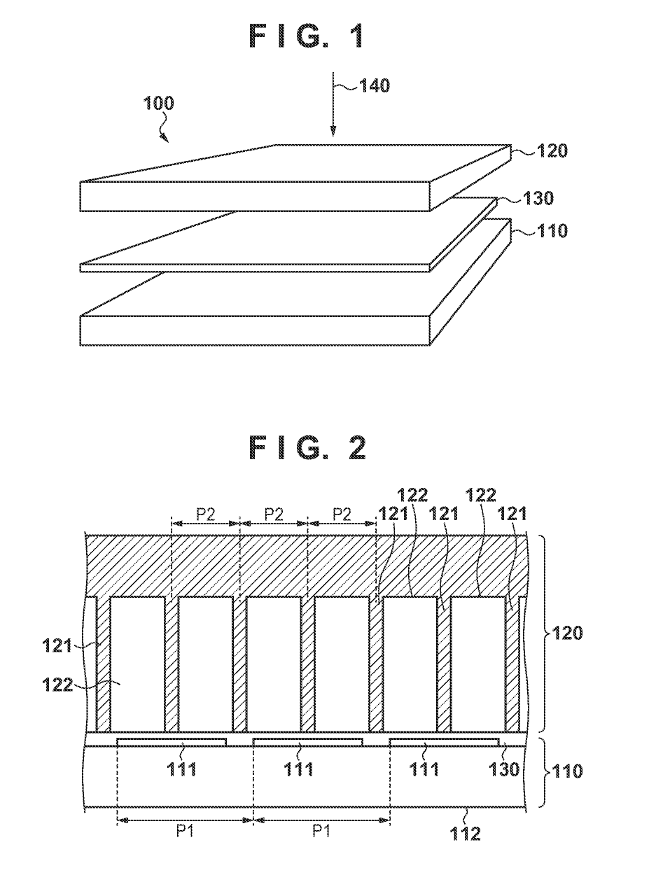

FIG. 1 is a schematic exploded view showing an example of the arrangement of a radiation imaging apparatus 100 (to be referred to as an “imaging apparatus 100” hereinafter). The imaging apparatus 100 includes a sensor substrate 110, a scintillator substrate 120, and a connecting member 130 which connects the sensor substrate 110 and the scintillator substrate 120. The sensor substrate 110 includes a sensor array in which, for example, sensors (photoelectric conversion elements) are arrayed. As indicated by an arrow in FIG. 1, radiation 140 enters the imaging apparatus 100, and the scintillator substrate 120 converts the radiation 140 into light. The sensor substrate 110 photoelectrically converts the light from the scintillator substrate 120, thereby obtaining an electrical signal. Based on the electrical signal obtained from the sensor substrate 110, the imaging apparatus 100 can cause, for example, a signal processing unit (not shown) to generate radiation image data. Note that X-rays can be used as a representative example of radiation. However, radiation can include α-rays, β-rays, and γ-rays in addition to X-rays.

### First Embodiment

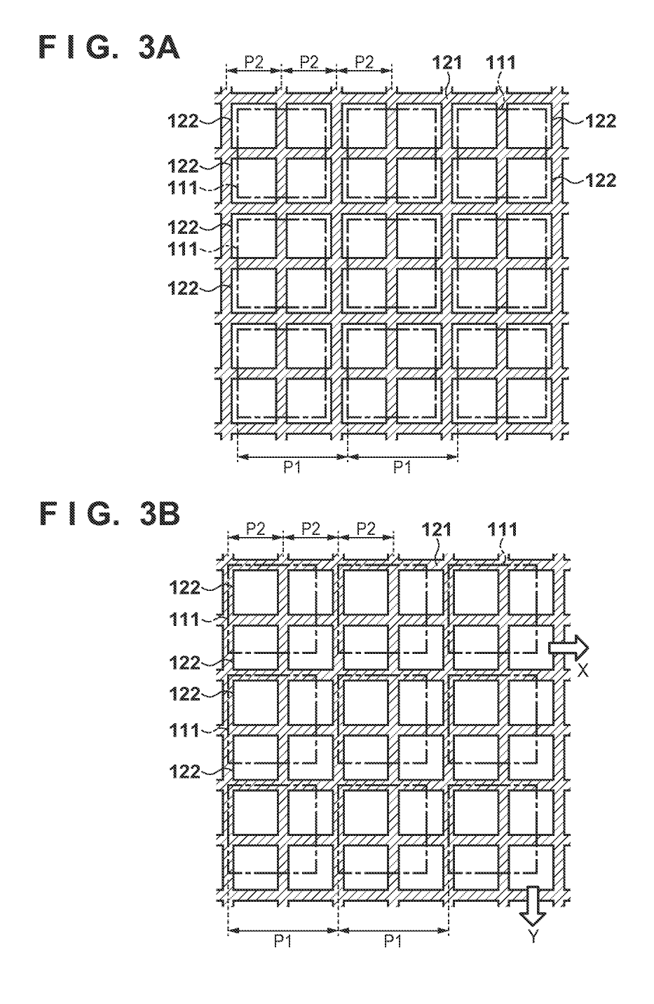

An imaging apparatus 100₁ according to the first embodiment will be described with reference to FIGS. 2, 3A, and 3B. FIG. 2 schematically shows the sectional structure of the imaging apparatus 100₁. A scintillator substrate 120 is arranged on a sensor substrate 110 via a connecting member 130. The sensor substrate 110 can be formed by arranging, on a substrate 112 made of glass or the like, a sensor array in which sensors 111 are arrayed. Each sensor 111 is a photoelectric conversion element, for which a CMOS sensor using crystal silicon, or a PIN sensor or MIS sensor using amorphous silicon can be used.

The scintillator substrate 120 includes scintillators 122 in a plurality of regions divided by members 121. As the members 121, light blocking members made of, for example, a metal may be used, or glass, silicon, or the like may be used. For example, CsI (cesium iodide) doped with Tl (thallium) or GOS (gadolinium sulfate) can be used for the scintillators 122.

Let P1 be the pitch of the sensors 111 in the sensor array, and P2 be the distance between the centers of two adjacent ones of the members 121, which sandwich the scintillator 122 in one divided region therebetween (the distance from the center of one portion to that of the other portion), in this example, the pitch of the divisions of the scintillators 122. In this case, the sensor substrate 110 and scintillator substrate 120 are arranged to satisfy a relationship P2=P1×1/n where n is an integer of 2 or larger.

FIG. 2 shows a case in which n=2. For example, in the sensor array having respective sensor 111 with a size of 160 μm×160 μm, the pitch P1 is set to 200 μm. In this case, for example, the pitch P2 is 100 μm, the width of each member 121 is 20 μm, and the size of each division (width of one region) is 80 μm.

The scintillator substrate 120 can be obtained by, for example, etching a plate material to form the members 121, forming openings (or trenches) for dividing the scintillators 122, and forming the scintillators 122 in the openings.

More specifically, a plate material to form the members 121 is prepared, a photoresist pattern corresponding to the shape of divisions is formed on the plate material, and the plate material is then etched. The etching depth corresponds to the height of the members 121 which divide the scintillators 122, and is, for example, 200 μm. In this way, openings for dividing the scintillators 122 are formed on the plate material. That is, the members 121 are obtained in the scintillator substrate 120.

Scintillators 122 are then formed in the openings formed in the plate material. First, a phosphor solution is obtained by mixing a phosphor material with a solvent or liquid adhesive. Note that if air bubbles enter the phosphor solution in the mixing step, defoaming processing is preferably performed by a centrifugal deaerator or the like after the mixing step. Subsequently, the phosphor solution is applied on the above-described members 121 (the plate material with the openings) to fill the openings. The phosphor solution can be applied by spin coating, slit coating, or print coating. Note that to prevent air bubbles from entering between the members 121 and the phosphor solution in the application step, the phosphor solution is preferably applied in a vacuum container. This makes it possible to obtain the scintillator substrate 120. Note that the scintillator substrate 120 may undergo heat treatment, as needed. This can remove unnecessary solvent components in the phosphor solution, or harden an adhesive member. Furthermore, air bubbles which entered in the above-described mixing step or application step can be removed by the heat treatment.

The sensor substrate 110 and the scintillator substrate 120 can be adhered by the connecting member 130. For the connecting member 130, for example, silicone-, acrylic-, or epoxy-based adhesive or pressure sensitive adhesive can be used.

FIGS. 3A and 3B are plan views each schematically showing the imaging apparatus 100₁, and especially show the positional relationship between the sensors 111 and scintillators 122. FIG. 3A shows a case in which the scintillator substrate 120 is appropriately arranged (alignment is preferable). FIG. 3B shows a case in which the scintillator substrate 120 is arranged to shift in the X and Y directions from a desired position (an alignment shift occurs).

If, for example, the pitch of the divisions of the scintillators 122 is equal to that of the sensors 111 (P2=P1), an alignment shift causes the scintillator in each divided region to be positioned across adjacent sensors. In this case, part of light generated by the scintillator is detected by a sensor adjacent to that which should detect the light, resulting in degradation in sharpness.

On the other hand, according to this embodiment (P2=P1×1/n), as shown in FIGS. 3A and 3B, it is possible to prevent the scintillator 122 from becoming positioned across two adjacent sensors due to a situation in which an alignment shift causes the scintillator 122 in each region to shift from a position immediately above the corresponding sensor 111. Alternatively, according to this embodiment, it is possible to decrease the total area of the scintillators 122 each of which is positioned across two adjacent sensors due to the alignment shift. According to this embodiment, therefore, degradation in sharpness due to an alignment shift is suppressed. That is, the tolerance range of an alignment shift is large. Such imaging apparatus is thus advantageous in terms of manufacturing.

The scintillators 122 are uniformly divided with respect to the respective sensors 111 by arranging the sensor substrate 110 and the scintillator substrate 120 to satisfy the relationship P2=P1×1/n. The imaging apparatus 100₁ is arranged so that the incident light amounts from the scintillators 122 of the respective sensors 111 are equal, and it is thus possible to reduce a distortion (moiré) in image data to be obtained from the imaging apparatus 100₁.

Note that the sensor substrate 110 may be adhered with the scintillator substrate 120 by putting an alignment mark on each of the sensor substrate 110 and the scintillator substrate 120. It is possible to reduce the alignment shift by adjusting the positions of the sensor substrate 110 and scintillator substrate 120 with reference to the marks, and adhering them.

Furthermore, it is possible to individually manufacture the sensor substrate 110 and scintillator substrate 120, and individually evaluate or test the qualities of the sensor substrate 110 and scintillator substrate 120. That is, this is advantageous in terms of manufacturing, as compared with a case in which evaluation or a test is performed after adhering the sensor substrate 110 and scintillator substrate 120.

### Second Embodiment

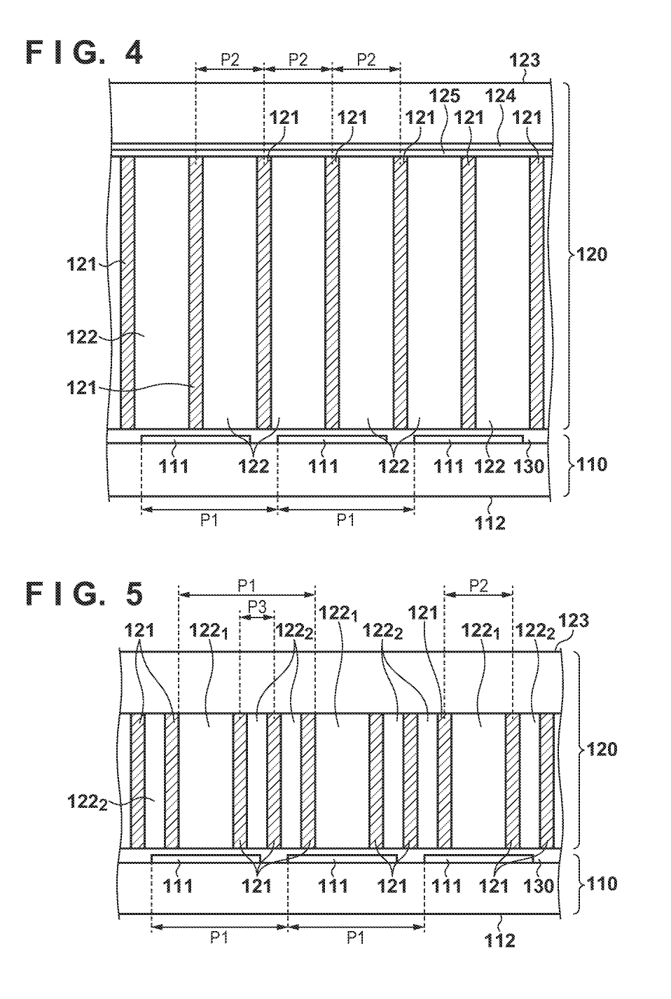

An imaging apparatus 100₂ according to the second embodiment will be described with reference to FIG. 4. FIG. 4 schematically shows the sectional structure of the imaging apparatus 100₂. The imaging apparatus 100₂ includes a substrate 123, a reflection film 124, and a connecting member 125 on the upper portion of a scintillator substrate 120. A manufacturing method according to this embodiment is different from that in the first embodiment in that the scintillator substrate 120 is obtained by using the substrate 123 as a base, and forming members 121 for dividing scintillators 122 on the substrate 123.

The reflection film 124 made of a metal or the like can be formed in the substrate 123 made of an organic resin such as a carbon resin. The reflection film 124 can be formed by, for example, deposition or sputtering. Note that if the substrate 123 made of, for example, a white polyester resin having a reflection function is used, the step of forming the reflection film 124 may be omitted.

On the other hand, a silicon wafer is prepared as a material for the members 121, and polished to have a desired thickness (for example, 400 μm). A photoresist pattern corresponding to the shape of the divisions is formed on the polished silicon wafer, and the silicon wafer is etched. With this processing, it is possible to obtain the silicon wafer including openings (or trenches) for dividing the scintillators 122, that is, the members 121 in the scintillator substrate 120. Note that the etching step is preferably performed by dry etching, thereby obtaining the members 121 which are thicker than that in the first embodiment. After that, a reflection member (not shown) made of a metal or the like may be formed on the surface (side surface) of each member 121, as needed.

The members 121 and the substrate 123 in which the reflection film 124 has been formed can be adhered by the connecting member 125. The same material as that of the connecting member 130 can be used for the connecting member 125. After that, similarly to the first embodiment, scintillators 122 can be formed in the openings formed according to the above-described procedure, thereby obtaining the scintillator substrate 120.

According to this embodiment, it is possible to form thick members 121, that is, thick scintillators 122, thereby increasing the amount of light generated by each scintillator 122. According to this embodiment, therefore, the present invention is advantageous in improving the light sensitivity, in addition to the effects in the first embodiment.

Furthermore, if a reflection member is formed on the side surface of each member 121, light generated in the divided region of each scintillator 122 is reflected toward the sensor 111 corresponding to the divided region, thereby further improving the light sensitivity. Also, by using a material having a refractive index smaller than that of the scintillators 122 for the members 121, light can be effectively, totally reflected on the interface between the member 121 and the scintillator 122, thereby improving the light sensitivity.

### Third Embodiment

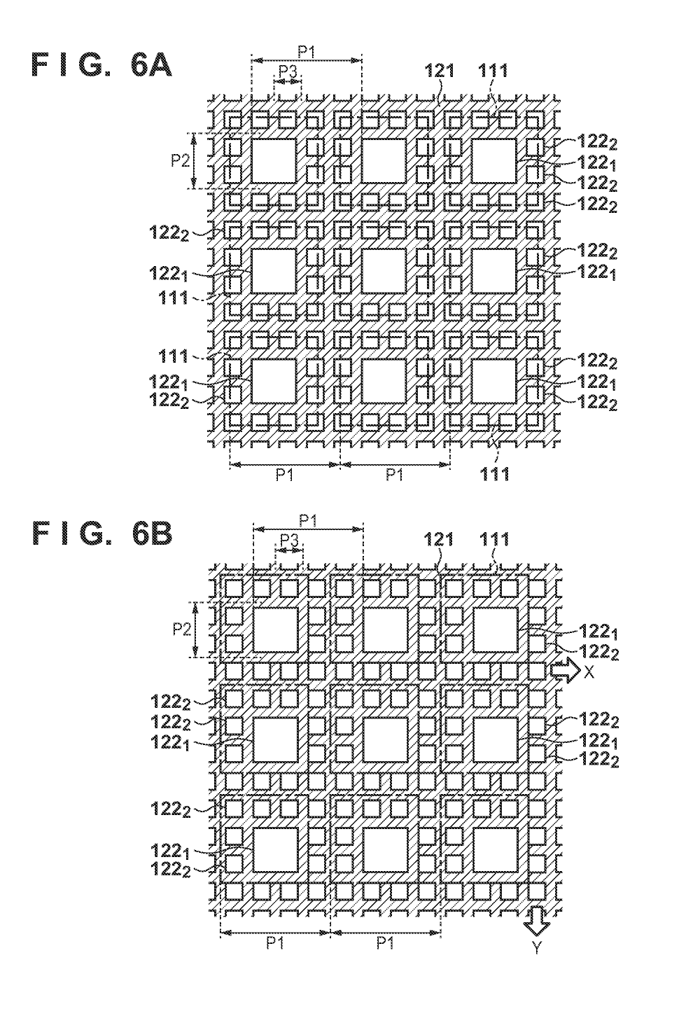

An imaging apparatus 100₃ according to the third embodiment will be described with reference to FIGS. 5, 6A, and 6B. FIG. 5 schematically shows the sectional structure of the imaging apparatus 100₃. In the first and second embodiments, the sizes of the divisions by the members 121, that is, the widths of the respective regions are equal. The present invention, however, is not limited to this arrangement. As will be exemplified in this embodiment, an arrangement including divided regions having different sizes may be used.

Similarly to FIGS. 3A and 3B, FIGS. 6A and 6B are plan views each schematically showing the imaging apparatus 100₃. In the imaging apparatus 100₃, scintillators 122₁ in first regions each having a large division and scintillators 122₂ in second regions each having a small division are formed in a scintillator substrate 120.

Let P1 be the pitch of sensors 111 in the sensor array, P2 be the distance between the centers of two adjacent ones of members 121, which sandwich one scintillator 122₁ in the first region therebetween, and P3 be the distance between the centers of two adjacent ones of the members 121, which sandwich one scintillator 122₂ in the second region therebetween.

The scintillators 122₁ in the first regions can be arrayed at the pitch P1 to correspond to the respective sensors 111, and formed to satisfy a relationship P2=P1×½. The scintillators 122₂ in the second regions can be formed to satisfy a relationship P3=P1×1/m where m is an integer of 3 or larger (in this example, m=4). For example, the pitch P1 is 200 μm, the pitch P2 is 100 μm, the pitch P3 is 50 μm, and the width of each member 121 is 20 μm.

Decreasing the size of each division effectively suppresses degradation in sharpness due to an alignment shift. However, the total area of the members 121 increases, so the light sensitivity may decrease. In this embodiment, it is possible to suppress degradation in sharpness while suppressing a decrease in light sensitivity, by arranging the scintillators 122₁ in the first regions each having a large division to correspond to the respective sensors 111.

In this arrangement, for example, even if the scintillator substrate 120 is arranged on the sensor substrate 110 to shift in the X or Y direction by 20 μm, each scintillator 122₁ in the first region is positioned on the corresponding sensor 111. Light generated by the scintillator 122₁ in the first region is, therefore, detected by the corresponding sensor 111. Some of the scintillators 122₂ in the second regions arranged around the scintillator 122₁ in the first region are positioned on the corresponding sensor 111, or are not positioned on a sensor adjacent to the corresponding sensor 111. Therefore, light generated by the scintillator 122₂ in the second region is detected by the corresponding sensor 111, or is not detected by the adjacent sensor. According to this embodiment, it is possible to suppress degradation in sharpness.

The scintillator substrate 120 according to the embodiment can be obtained by applying, on a substrate 123, a material to form members 121, and forming members 121 which should divide the scintillators 122₁ and 122₂ by etching or the like as in the first or second embodiment. An organic resin such as a carbon resin, or a glass substrate can be used for the substrate 123. The substrate 123 is formed to have a thickness which allows radiation to pass through. A glass paste or organic material can be used for the members 121.

In this embodiment, the scintillators 122₁ in the first regions having a large division are arranged to correspond to the respective sensors 111. This can suppress degradation in sharpness while suppressing a decrease in light sensitivity. According to this embodiment, therefore, it is possible to obtain the same effects as those in the first embodiment.

In this embodiment, each of the scintillators 122₁ in the first regions and the scintillators 122₂ in the second regions is shown to have a square shape. The present invention, however, is not limited to this. For example, at least some of the scintillators 122₂ in the second regions may be formed to have, for example, a rectangular shape.

Although the three embodiments have been explained above, the present invention is not limited to them. The present invention can be appropriately changed in accordance with the purpose, state, application, function, and other specifications, and can also be implemented by another embodiment.

(Imaging System)

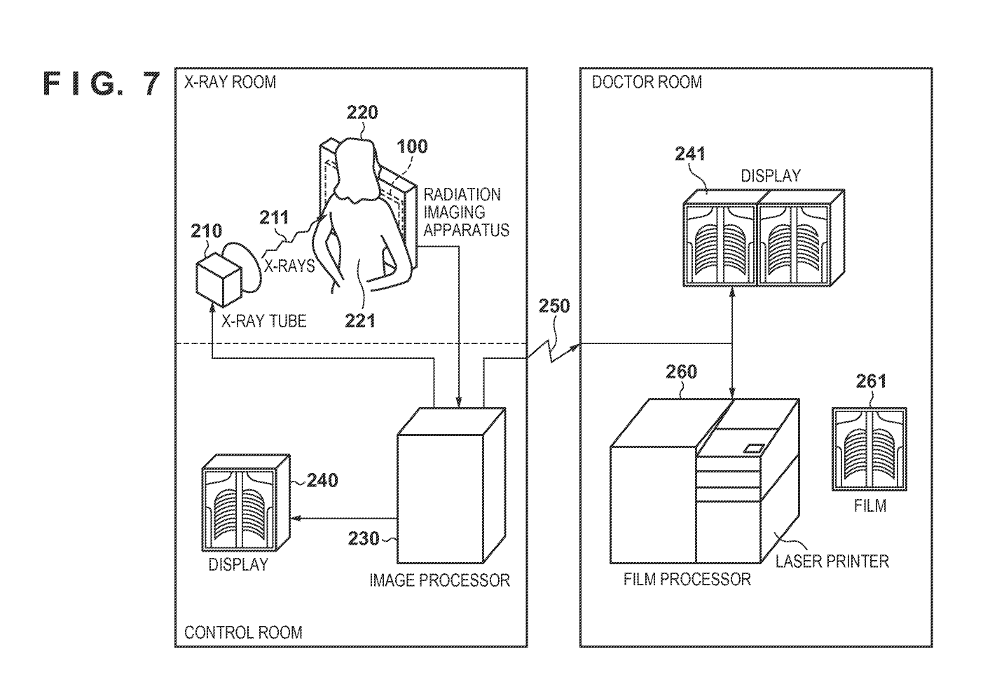

The imaging apparatus 100 (100₁ to 100₃) according to each of the above-described embodiments is applicable to an imaging system represented by a radiation inspection apparatus and the like. The imaging system includes, for example, the imaging apparatus 100, a signal processing unit including an image processor, a display unit including a display, and a radiation source for generating radiation. For example, as shown in FIG. 7, X-rays 211 generated by an X-ray tube 210 are transmitted through a chest 221 of a subject 220 such as a patient, and enter the imaging apparatus 100. The incident X-rays include in-vivo information of the subject 220. The imaging apparatus 100 obtains electrical information corresponding to the incident X-rays 211. After that, this information can be digitally converted, undergo image processing by an image processor 230 (signal processing unit), and then be displayed on a display 240 (display unit) in a control room. This information can be transferred to a remote place through a network 250 (transmission processing unit) such as a telephone, a LAN, or the Internet. This makes it possible to display the information on a display 241 in another place such as a doctor room, and allow a doctor in a remote place to make diagnosis. In addition, this information can be stored in, for example, an optical disk. Alternatively, a film processor 260 can record the information on a recording unit such as a film 261.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-091787, filed Apr. 24, 2013, which is hereby incorporated by reference herein in its entirety.

What is claimed is:

1. A radiation imaging apparatus comprising:
a sensor array in which a plurality of sensors are arrayed; and
scintillators arranged in a plurality of regions divided by members on the sensor array,
wherein a relationship P2<P1 is satisfied,
where P1 represents a pitch of the plurality of sensors in the sensor array, and
P2 represents a distance between centers of two adjacent ones of the members, which sandwich one of the plurality of regions therebetween.

2. The apparatus according to claim 1, wherein
a relationship P2=P1×1/n is satisfied where n is an integer not less than 2.

3. The apparatus according to claim 1, wherein
the plurality of regions include a plurality of first regions which are arrayed at a pitch of P1×½, and a distance between centers of two adjacent ones of the members, which sandwich one of the plurality of first regions therebetween, is P1×½.

4. The apparatus according to claim 1, wherein
the plurality of regions include a plurality of first regions which are arrayed at a pitch of P2 and a plurality of second regions which are arranged around each of the plurality of first regions, and
the plurality of first regions are arranged in one-to-one correspondence with the plurality of sensors.

5. The apparatus according to claim 4, wherein
a distance between centers of two adjacent ones of the members, which sandwich one of the plurality of first regions therebetween, is P1×½, and a distance between centers of two adjacent ones of the members, which sandwich one of the plurality of second regions therebetween, is P1×1/m where m is an integer not less than 3.

6. The apparatus according to claim 1, wherein
the members which divide the plurality of regions have a refractive index smaller than that of the scintillators.

7. The apparatus according to claim 1, wherein
each of the members which divide the plurality of regions includes a reflection member configured to reflect light generated in one of the divided regions toward the sensor corresponding to the divided region.

8. A radiation inspection apparatus comprising:
a radiation imaging apparatus according to claim 1; and
a radiation source configured to generate radiation.

9. A method of manufacturing a radiation imaging apparatus, comprising:
a first step of forming a sensor array in which a plurality of sensors are arrayed; and
a second step of forming scintillators in a plurality of regions divided by members on the sensor array,
wherein a relationship P2<P1 is satisfied where P1 represents a pitch of the plurality of sensors in the sensor array, and P2 represents a distance between centers of two adjacent ones of the members, which sandwich one of the plurality of regions therebetween.

10. The method according to claim 9, wherein
a relationship P2=P1×1/n is satisfied where n is an integer not less than 2.

11. The method according to claim 9, wherein
in the second step,
the plurality of regions include a plurality of first regions which are arrayed at a pitch of P1×½, and
the scintillators are formed so that a distance between centers of two adjacent ones of the members, which sandwich one of the plurality of first regions therebetween, is P1×½.

12. The method according to claim 9, wherein
in the second step,
the plurality of regions include a plurality of first regions which are arrayed at a pitch of P2 and a plurality of second regions which are arranged around each of the plurality of first regions, and
the scintillators are formed so that the plurality of first regions are arranged in one-to-one correspondence with the plurality of sensors.

13. The method according to claim 12, wherein
a distance between centers of two adjacent ones of the members, which sandwich one of the plurality of first regions therebetween, is P1×½, and
a distance between centers of two adjacent ones of the members, which sandwich one of the plurality of second regions therebetween, is P1×1/m where m is an integer not less than 3.

14. The method according to claim 9, wherein
in the second step, a material having a refractive index smaller than that of the scintillators is used for the members.

15. The method according to claim 9, wherein
in the second step, reflection members are used as the members.
